(19) United States
(12) Patent Application Publication
(10) Pub. No.: US 2011/0216353 A1
(43) Pub. Date: Sep. 8, 2011

(54) Control point and method for controlling print

(75) Inventors: Bo-Yeon Kim, Suwon-si (KR); Dae-hyun Kim, Yongin-si (KR)

(73) Assignee: Samsung Electronics Co., Ltd., Suwon-si (KR)

(21) Appl. No.: 12/923,794

(22) Filed: Oct. 7, 2010

(30) Foreign Application Priority Data
Mar. 2, 2010 (KR) 2010-0018547

(51) Int. Cl. G06F 3/12

(52) U.S. Cl. 358/1.15

(57) ABSTRACT

A control point including a user interface to select an image forming apparatus to perform a printing job among image forming apparatuses connected using a digital living network alliance, a storage unit to store a lookup table which records at least one of information of printing data formats supportable by the selected image forming apparatus and printing time information, a format selector to select a printing data format based on the lookup table, a driver unit to generate printing data according to the selected printing data format, and a communication unit to transmit the generated printing data to the selected image forming apparatus.

### CROSS-REFERENCE TO RELATED APPLICATIONS

This application claims the benefit of Korean Patent Application No. 2010-0018547, filed in the Korean Intellectual Property Office on Mar. 2, 2010, the disclosure of which is incorporated herein by reference.

### BACKGROUND

1. Field

Aspects of the present embodiment relate to a control point and a method for controlling a printing operation, and more particularly, to an image forming apparatus which is capable of changing a printing data format automatically to print in a digital living network alliance (DLNA) scheme for the sake of improving a printing speed, and a method for controlling an printing operation.

2. Description of the Related Art

An image forming apparatus is an apparatus to print printing data generated by a terminal apparatus such as a computer on recording paper, and the examples of the image forming apparatus include a copier, a printer, a facsimile machine, and a multi-functional peripheral (MFP) combining the functions of the aforementioned devices in a single device.

A recently widespread image forming apparatus may support a digital living network alliance (DLNA) standard and thus may receive a printing job through not only a terminal apparatus such as a computer but also a control point.

The DLNA, which is an organization for standardization of a digital information technology product, was established to provide a standard to allow data such as music, pictures, and moving pictures to be shared among devices. The DLNA aims at establishing a mutually compatible platform based on a standard already published in the industry and achieving convergence among the industries. The DLNA promotes introduction of a guideline for the manufacturers of household appliances, personal computers, and wireless devices based on the Universal Plug and Play (UPnP) protocols which are being widely used by these manufacturers.

Accordingly, users can enjoy diverse contents within a DLNA network using a control point, and can output a desired content to an image forming apparatus connected over the DLNA network.

According to a DLNA standard protocol, since an extensible hypertext markup language (XHTML) document type is set as a default document type, a related-art control point generates only XHTML printing data using an XHTML composer.

However, it takes more time to print an XHTML type document than when printing a printer command language (PCL) type document. More specifically, if an image file is printed in a DLNA printing system, a printing speed for the PCL type is typically about 1.8 times higher than a printing speed for the XHTML type. Diverse examples of the printing speed for the XHTML type and the PCL type when the image file is printed are illustrated in FIG. 2.

Accordingly, there is a need for a method for changing a printing data format automatically for the sake of improving a printing speed under a DLNA printing environment.

### SUMMARY

Aspects of the present embodiments relate to an image forming apparatus to change a printing data format automatically to print in a DLNA scheme for the sake of improving a printing speed, and a method of controlling a printing operation.

Additional aspects and/or advantages will be set forth in part in the description which follows and, in part, will be apparent from the description, or may be learned by practice of the invention.

The foregoing and/or other aspects are achieved by providing a control point which is connected to a plurality of image forming apparatuses using a digital living network alliance (DLNA), the control point including: a user interface to select an image forming apparatus to perform a printing job among the image forming apparatuses connected using the DLNA, a storage unit to store a lookup table which records at least one of information of printing data formats supportable by the selected image forming apparatus and printing time information, a format selector to select a printing data format based on the lookup table, a driver unit to generate printing data according to the selected printing data format, and a communication unit to transmit the generated printing data to the selected image forming apparatus.

The lookup table may include a table which contains printing times classified by content size.

The lookup table may include a table which contains predetermined printing data formats classified by content size and output layout.

The control point may further include a lookup table update unit to update the lookup table using a printing time for the printing job when printing of the printing job has been completed.

The format selector may select a printing data format using a size of a content which is commanded to be printed and the lookup table.

The user interface may receive setting of printing options for the printing data, and the format selector may select a printing data format using an output layout among the set printing options and the lookup table.

The communication interface may search for connectible image forming apparatuses if a printing command is received, and the user interface may receive a selection of an image forming apparatus to perform a printing job from the searched image forming apparatuses.

The foregoing and/or other aspects are also achieved by providing a method for controlling a printing operation of a control point which is connected to a plurality of image forming apparatuses using a DLNA, the method including: selecting an image forming apparatus to perform a printing job among the image forming apparatuses connected using the DLNA, selecting a printing data format using a lookup table which records at least one of information of printing data formats supportable by the selected image forming apparatus and printing time information, generating printing data according to the selected printing data format, and transmitting the generated printing data to the selected image forming apparatus.

The lookup table may include a table which contains printing times classified by content size.

The lookup table may include a table which contains predetermined printing data formats classified by content size and output layout.

The method may further include updating the lookup table using the printing time for the printing job when printing of the printing job has been completed.

The selecting the printing data format may include selecting a printing data format using a size of a content which is commanded to be printed and the lookup table.

The method may further include receiving setting of printing options for the printing data, and the selecting the printing data format may include selecting a printing data format using an output layout among the set printing options and the lookup table.

The method may further include searching for an image forming apparatus if a printing command is received, and the selecting the image forming apparatus may include selecting an image forming apparatus to perform a printing job among the searched image forming apparatuses.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating a control point according to an exemplary embodiment;

FIGS. 2 and 3 are views illustrating examples of a lookup table according to an exemplary embodiment;

FIG. 4 is a flowchart illustrating operation performed between a control point and an image forming apparatus according to an exemplary embodiment;

FIGS. 5 to 11 are views illustrating diverse examples of a user interface (UI) window which is displayed on a user interface of FIG. 1;

FIG. 12 is a flowchart illustrating a method for controlling a printing operation of a control point according to an exemplary embodiment; and

FIG. 13 is a flowchart illustrating operations of selecting a format and generating printing data in detail.

### DETAILED DESCRIPTION

Reference will now be made in detail to the exemplary embodiments, examples of which are illustrated in the accompanying drawings, wherein like reference numerals refer to like elements throughout. The embodiments are described below by referring to the figures.

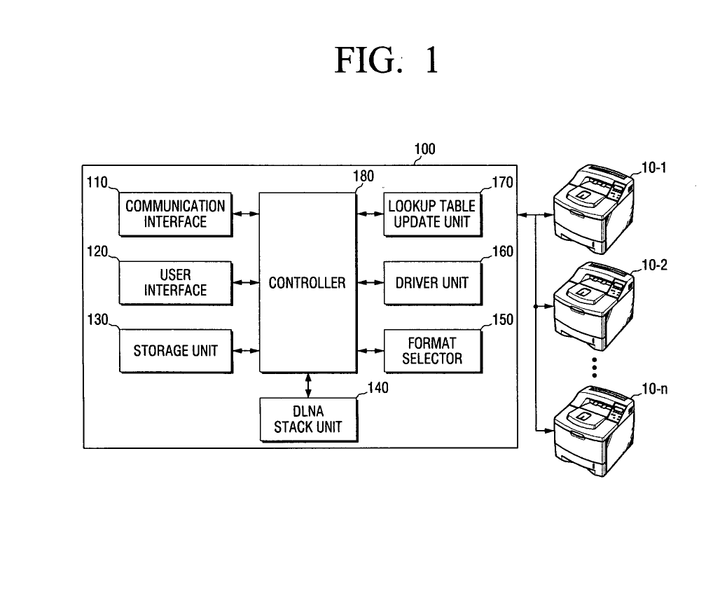

FIG. 1 is a block diagram illustrating a control point 100 according to an exemplary embodiment. The control point 100 is connectable to at least one image forming apparatus according to a digital living network alliance (DLNA) scheme, and transmits printing data to the image forming apparatus to perform a printing operation.

The control point 100 is a DLNA apparatus such as a mobile phone that can share contents with the other DLNA apparatuses 10-1, 10-2, . . . , 10-n within a DLNA network, and is connected to the image forming apparatuses 10-1, 10-2, . . . , 10-n within the DLNA network to be able to print contents. For example, the control point 100 may be one of a digital media server (DMS), a digital media player (DMP), and a digital media renderer (DMR), which are prescribed in the DLNA guide line.

The DMS recited herein refers to an apparatus to provide a function of a media server device (MSD) in the UPnP AV area, that is, a function of providing digital media contents, and to search for digital media contents in the DMS so that a DLNA network user can display or distribute the contents. For example, the DMS may include a video cassette recorder (VCR), a compact disk (CD) player, a digital versatile disk (DVD) player, an MP3 player, a set-top box (STB), a TV tuner, a radio tuner, and a personal computer (PC).

The DMR serves to execute selected media and may include a TV and a stereo speaker. The DMP is a DMR including a control point (UPnP control point) and performs functions of a media renderer device (MRD) and a media render control point (MRCP), that is, selecting, controlling and executing contents.

More specifically, the control point 100 may include a communication interface 110, a user interface 120, a storage unit 130, a DLNA stack unit 140, a format selector 150, a driver unit 160, a lookup table update unit 170, and a controller 180.

The communication interface 110 is connected to the DLNA network and shares contents with the other DLNA apparatuses 10-1, 10-2, . . . , 10-n in the DLNA network. More specifically, the communication interface 110 communicates with another DLNA apparatus in the DLNA network according to the UPnP standard to be able to share contents stored in another DLNA apparatus.

The contents recited herein may include image data, text, hypertext markup language (HTML) document, and a file which is capable of being direct-printed in an image forming apparatus. The direct-printing refers to a printing method that can print simply by transmitting a corresponding file to an image forming apparatus without additional conversion of the file. For example, JPG, PDF, and XPS files can be direct-printed.

The communication interface 110 searches for at least one image forming apparatus 10-1, 10-2, . . . , 10-n connected to the DLNA network. The searched image forming apparatus 10-1, 10-2, . . . , 10-n may be displayed through the user interface 120.

The communication interface 110 exchanges printing data with the image forming apparatuses 10-1, 10-2, . . . , 10-n. More specifically, the communication interface 110 may be connected to the image forming apparatuses 10-1, 10-2, . . . , 10-n in various communication ways, such as near field communication (NFC), Wi-Fi, Bluetooth, and may transmit printing data generated by the driver unit 160, which will be described below, to an image forming apparatus selected by the user.

The communication interface 110 may receive an event from an image forming apparatus 10 which is performing a printing job. The event may be displayed through the user interface 120 for the user. If the event is a job completion event, information regarding the event may be transmitted to the lookup table update unit 170.

The event recited herein may include an event which occurs in relation to a printing job in the image forming apparatus 10 and an event which occurs according to a change in the state of the image forming apparatus 10. For example, the even may be a print completion event indicating that a printing job has been completed.

The user interface 120 has a plurality of function keys through which a user sets or selects diverse functions supported by the control point 100. The user interface 120 may display diverse information provided by the control point 100. The user interface 120 may be implemented as a device realizing input and output operations simultaneously such as a touch pad, or as a device combining a mouse and a monitor. Accordingly, the user may select an image forming apparatus from among the searched image forming apparatuses through a UI window provided by the user interface 120, and may select a content to be printed. The user may set options for a corresponding content through the UI window provided by the user interface 120.

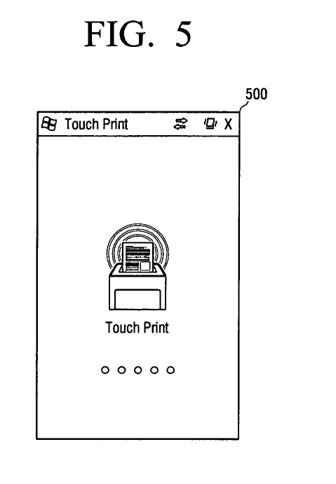

If the user interface 120 is notified of an event by the image forming apparatus 10 which is performing a printing job, the user interface 120 may display the event for the user. The examples of the UI window displayed on the user interface 120 will be described below with reference to FIGS. 5 to 11.

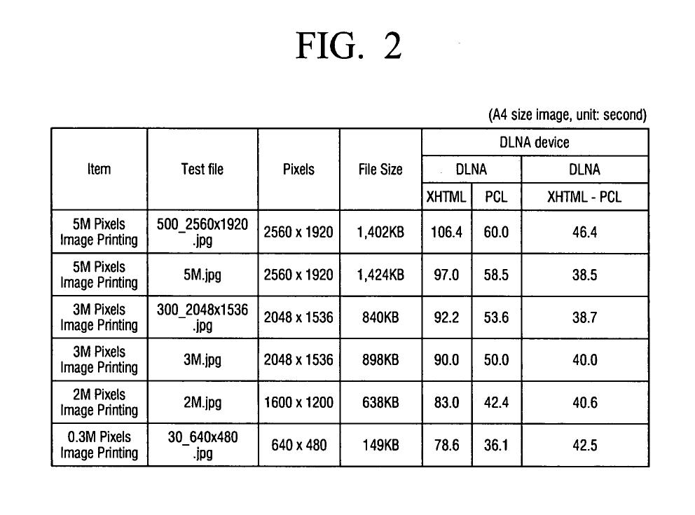

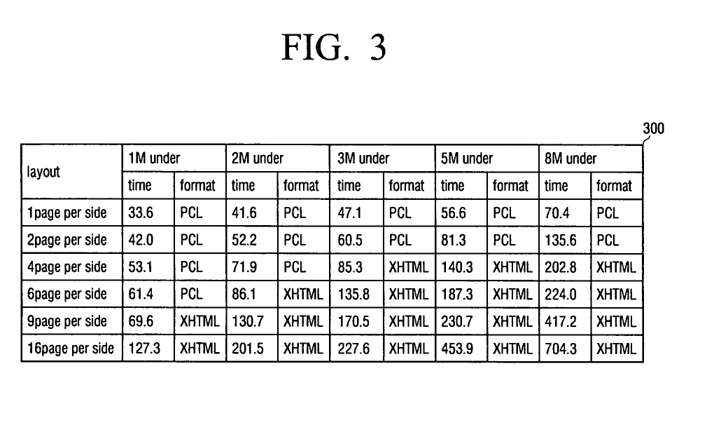

The storage unit 130 stores contents. The storage unit 130 may store printing data generated by the driver unit 160 which will be described below. The storage unit 130 may store a lookup table to be used to select a printing data format. Detailed examples of the lookup table will be described below with reference to FIGS. 2 and 3. The storage unit 130 may be implemented as an internal storage medium or an external storage medium of the control point 100, such as a removable disk including a USB memory, a storage medium connected to a host, and a web server over a network.

The DLNA stack unit 140 may control the communication interface 110 to communicate with the image forming apparatuses 10-1, 10-2, . . . , 10-n according to the DLNA standard. More specifically, if a content to be printed and an image forming apparatus are selected by the user, the DLNA stack unit 140 may request the image forming apparatus 10 to perform a printing job. Also, the DLNA stack unit 140 may receive a job ID and URL information from the image forming apparatus 10 in response to the printing job performance request, and may transmit printing data generated by the driver unit 160 to an address corresponding to the URL information.

The format selector 150 selects a printing data format based on the lookup table. Specifically, the format selector 150 may select a printing data format that can minimize a printing time based on the lookup table stored in the storage unit 130. More specifically, in the case where the lookup table stored in the storage unit 130 contains printing times classified by content size, the format selector 150 compares the printing times which correspond to the size of a content to be printed and are also supported by a selected image forming apparatus, thereby selecting a printing data format having a minimum printing time as a printing data format for a current printing job.

Also, in the case where the lookup table stored in the storage unit 130 contains predetermined printing data formats classified by content size, the format selector 150 may select a predetermined printing data format corresponding to a size of a content to be printed as a printing data format for a current printing job.

The format selector 150 may select a printing data format using an output layout among set printing options and the lookup table. Specifically, in the case where the user sets printing options, the format selector 150 may extract output layout information from the set printing options and select a printing data format based on the extracted output layout. More specifically, in the case where the lookup table stored in the storage unit 130 contains printing times classified by content size and output layout, the format selector 150 compares the printing times which correspond to a content to be printed and a corresponding output layout, thereby selecting a printing data format having a minimum printing time.

In the case where the lookup table stored in the storage unit 130 contains predetermined printing data formats classified by content size and output layout, the format selector 150 selects a predetermined printing data format corresponding to a content to be printed and a corresponding output layout as a printing data format for a current printing job.

The driver unit 160 includes a plurality of composers corresponding to printing data formats which are supported by the image forming apparatus 10. For example, the driver unit 160 may include an XHTML composer (or XHTML-printer interpreter) and a PCL composer. Accordingly, the driver unit 160 generates printing data according to the printing data format selected by the format selector 150. For example, if a PCL format is selected by the format selector 150, the driver unit 160 may generate PCL printing data using the PCL composer. If an XHTML format is selected by the format selector 150, the driver unit 160 may generate XHTML printing data using the XHTML composer.

Once a printing job has been completed, the lookup table update unit 170 updates the lookup table using the printing time which is spent in performing the printing job. Specifically, once a printing job has been completed, the lookup table update unit 170 determines whether update is necessary by comparing the printing time spent in performing the printing job with data in the lookup table, and, if so, updates the lookup table. For example, if it takes 40 seconds to perform a printing job but if the record on the lookup table shows 30 seconds under the same condition, time information recorded on the lookup table is updated to show 40 seconds. Also, if a current printing job is performed using a PCL format and if a printing time for the current printing job is shorter than the printing time of a predetermined format (for example, XHTML) in the lookup table, the predetermined format in the lookup table is updated from the XHTML to the PCL.

The controller 180 controls the respective components of the control point 100. Specifically, the controller 180 may control the communication interface 110 to search for a connectable image forming apparatus within the DLNA network. Such a searching operation may be performed prior to receiving a printing job command. That is, the controller 130 may periodically search for a connectable image forming apparatus 10 and pre-stores a list of image forming apparatuses which are searched in the storage unit 130.

The controller 180 may control the user interface 120 to display the searched image forming apparatus. If a content and an image forming apparatus are selected by the user, the controller 180 may control the format selector 150 to select a printing data format having a minimum printing time, which corresponds to the selected content, and may control the driver unit 160 to generate printing data according to the selected printing data format. Also, the controller may control the DLNA stack unit 140 and the communication interface 110 to transmit the generated printing data to the image forming apparatus selected by the user.

If an event is notified by the image forming apparatus which is performing a printing job, the controller 180 may control the user interface 120 to display the event. If the received event is a printing completion event, the controller 180 may control the lookup table update unit 170 to update the lookup table stored in the storage unit 130.

As described above, the control point 100 according to an exemplary embodiment changes the printing data format automatically using the lookup table containing printing data formats supportable by the image forming apparatus or printing time information, and transmits printing data generated according to the printing data format to the image forming apparatus, so that the printing speed can be improved.

FIGS. 2 and 3 are views illustrating examples of a lookup table according to an exemplary embodiment.

Referring to FIG. 2, a lookup table 200 stores printing times classified by content size by printing data format. Accordingly, the format selector 150 compares printing times corresponding to a content to be printed by printing data format, thereby selecting a printing data format having a minimum printing time.

Referring to FIG. 3, a lookup table 300 stores predetermined formats classified by content size and output layout, and corresponding printing times of the formats. Accordingly, the format selector 150 selects a printing data format which corresponds to a printing time of a content to be printed and an output layout among printing options set by the user, as a printing data format for a current printing job.

Although the lookup table shown in FIGS. 2 and 3 is concerned with only a single image forming apparatus, the lookup table may be provided for each of the image forming apparatuses. Also, such a lookup table may be updated as described above and may be created by an initial manufacturer.

Although in FIGS. 1 to 3 only the content size and the output layout are described as a factor for selecting a printing data format, another factor for controlling a printing speed according to a printing data format may be used in addition to the content size and the output layout.

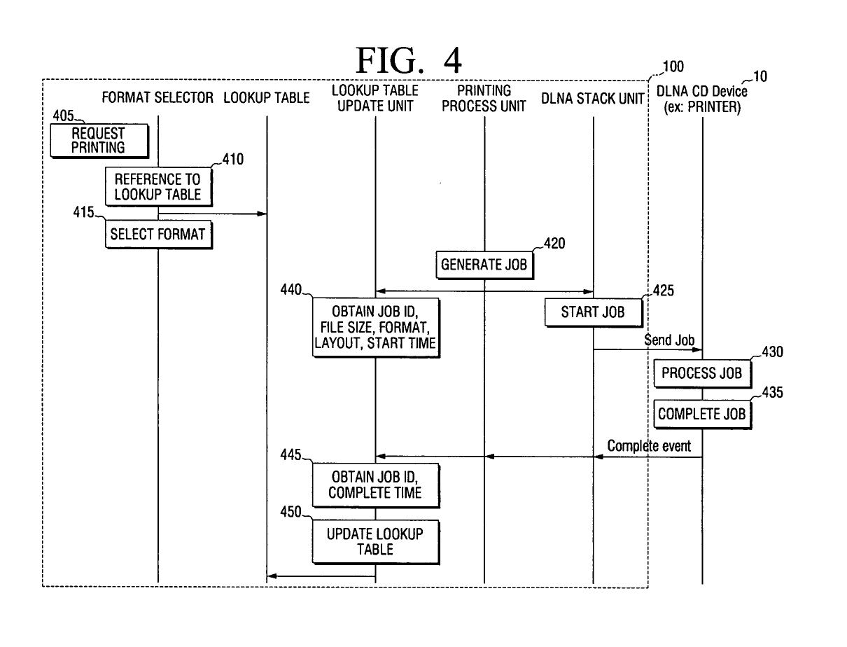

FIG. 4 is a flowchart illustrating operation performed between a control point 100 and an image forming apparatus 10 according to an exemplary embodiment.

Referring to FIG. 4, if a printing request is received (S405), the lookup table is referred (S410) and a printing data format for a content selected by the user is selected (S415). Selecting a printing data format using the lookup table was described above with reference to FIGS. 1 to 3 and thus a detailed description thereof will be omitted.

If the printing data format is selected, a printing job (printing data) corresponding to the selected printing data format is generated (S420). The DLNA stack unit 140 of the control point 100 transmits the generated printing job (printing data) to the image forming apparatus 20 such that the image forming apparatus 10 performs printing with respect to the printing job (S430).

If a job completion event is generated in the image forming apparatus 10 as the printing job has been completed (S435) and if the DLNA stack unit 140 receives the job completion event, the DLNA stack unit 140 transmits job completion event information to the lookup table update unit 170, and the lookup table update unit 170 obtains diverse information for the current printing job (S440 and S445), thereby updating the lookup table (S450).

FIGS. 5 to 11 are views illustrating diverse examples of a user interface (UI) window which is displayed on the user interface 120 of FIG. 1.

Referring to FIG. 5, a UI window 500 is an example of a UI window which is displayed if a user selects a printing command icon.

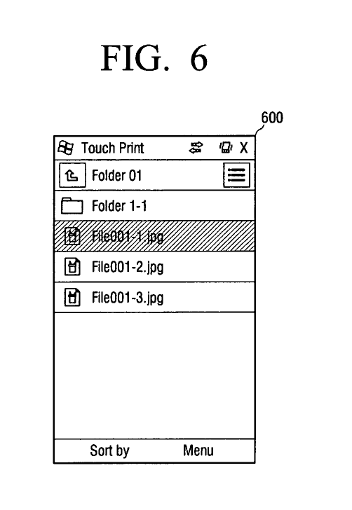

If the user inputs a printing command through the UI window, the user interface 120 may display a UI window 600 as shown in FIG. 6.

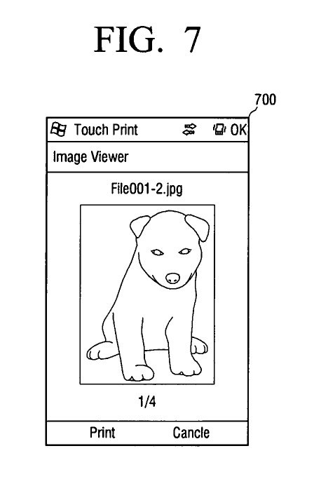

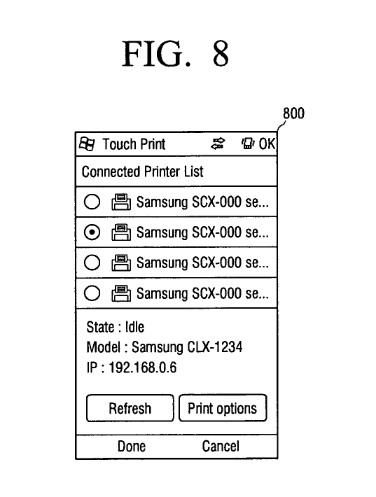

Referring to FIG. 6, the UI window 600 displays contents which are stored in the control point 100. The user may select a content to be printed through the UI window 600, and if the user selects a content to be printed, a UI window 700 and 800 shown in FIGS. 7 and 8 may be displayed.

Referring to FIG. 7, the UI window 700 displays the content selected by the user. Through the UI window 700, the user confirms the content to be printed and selects whether to print the currently displayed content.

Referring to FIG. 8, the UI window 800 displays a plurality of connectible image forming apparatuses. Using the UI window 800, the user selects an image forming apparatus to perform printing.

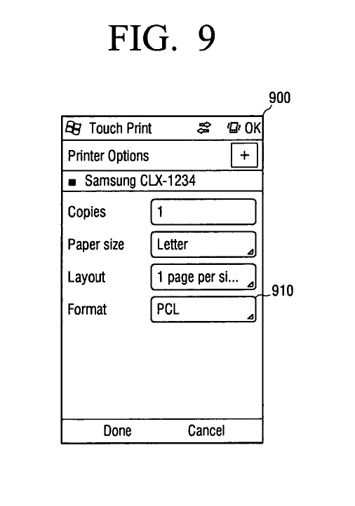

Referring to FIG. 9, a UI window 900 is displayed to receive setting of printing options to be applied to the content selected by the user. The user may select diverse printing options for the current content using the UI window 900. Also, the user may select a printing data format using an area 910. The area 910 may display a printing data format which is selected using the lookup table as described above in relation to the format selector 150 of FIG. 1.

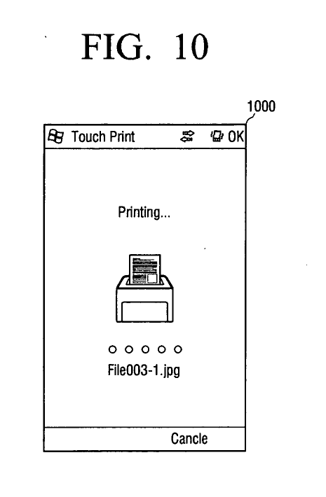

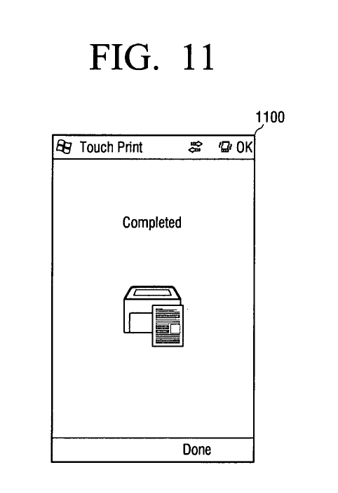

Referring to FIG. 10, a UI window 1000 displays a current state of the printing job. If printing of the current printing job has been completed, a UI window 1100 shown in FIG. 11 may be displayed.

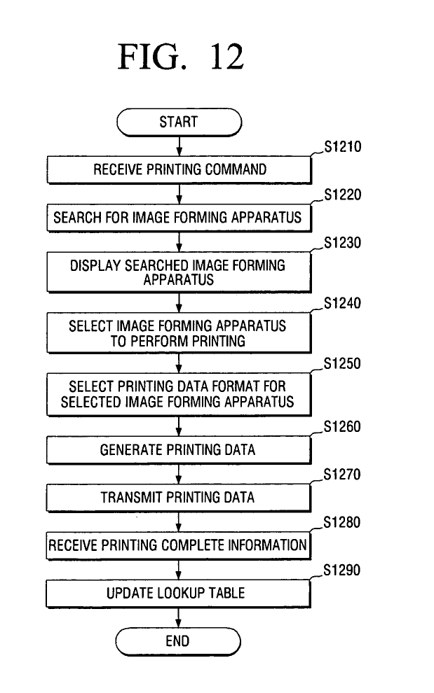

FIG. 12 is a flowchart illustrating a method for controlling a printing operation of a control point according to an exemplary embodiment.

If a printing command is received from the user (S1210), connectible image forming apparatuses are searched (S1220). Such a searching operation may be performed prior to receiving a printing command.

If connectible image forming apparatuses are searched, the searched image forming apparatuses are displayed (S1230), and one of them is selected to perform a printing job (S1240).

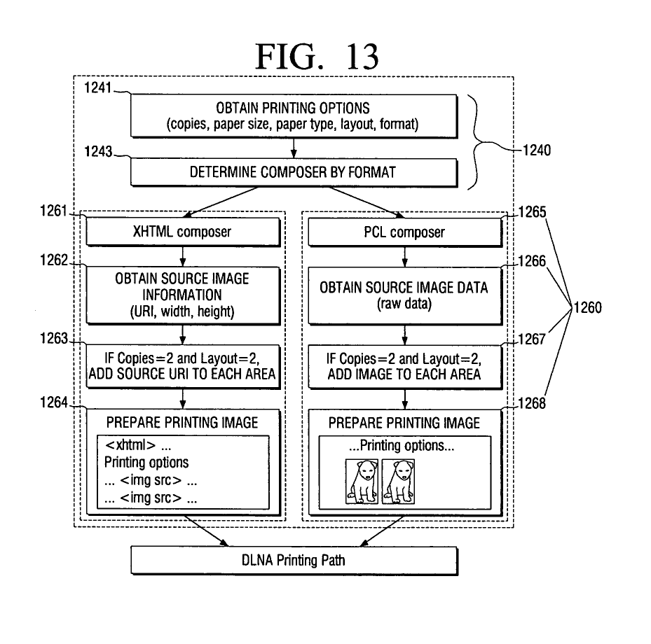

If an image forming apparatus to perform a printing job is selected by the user, a printing data format to be transmitted to the selected image forming apparatus is selected (S1250), and printing data corresponding to the selected printing data format is generated (S1260). The operations of selecting the printing data format and generating the printing data will be explained in detail below with reference to FIG. 13.

FIG. 13 is a flowchart illustrating the operations of selecting the printing data format and generating the printing data of FIG. 12 in detail.

Information of printing options selected by the user is obtained (S1241), and a printing data format is selected using one of the printing options that corresponds to a selection factor in the lookup table, for example, an output layout (S1243). The operation of selecting the printing data format using the lookup table was described above with reference to FIGS. 1 to 3 and thus a detailed description thereof will be omitted.

If the selected printing data format is an XHTML format, XHTML printing data for a content a printing command of which is input is generated using the XHTML composer 1261 (S1261, S1263, S1264). The generated XHTML printing data may not include a content. Since this operation is the same as in a well-known DLNA printing process, a detailed description thereof will be omitted.

If the selected printing data format is a PCL format, PCL printing data is generated using the PCL composer 1265 (S1266, S1267, S1268). Since the operation of generating the PCL printing data using the PCL composer is the same as in a well-known local printing process, a detailed description thereof will be omitted.

If the printing data is generated in the process shown in FIG. 13, the generated printing data is transmitted to the selected image forming apparatus (S1270). The image forming apparatus performs a printing job in response to the transmission of the printing data, and, if an event indicating that the printing job has been completed is received from the image forming apparatus (S1280), the lookup table is be updated using the printing time for the printing job (S1290).

According to the method for controlling the printing operation according to an exemplary embodiment, the printing data format is automatically changed using the lookup table which records printing data format information and printing time information supportable by the image forming apparatus 10, and the printing data generated according to the printing data format is transmitted to the image forming apparatus 10, so that the printing speed can be improved. The method of FIG. 13 may be executed in the control point 100 having the configuration of FIG. 1 or may be executed any other control point having a different configuration.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A control point which is connected to a plurality of image forming apparatuses using a digital living network alliance (DLNA), the control point comprising:
a user interface to select an image forming apparatus to perform a printing job among the image forming apparatuses connected using the DLNA;
a storage unit to store a lookup table which records at least one of information of printing data formats supportable by the selected image forming apparatus and printing time information;
a format selector to select a printing data format based on the lookup table;
a driver unit to generate printing data according to the selected printing data format; and
a communication unit to transmit the generated printing data to the selected image forming apparatus.

2. The control point according to claim 1, wherein the lookup table comprises a table which contains printing times classified by content size.

3. The control point according to claim 1, wherein the lookup table comprises a table which contains predetermined printing data formats classified by content size and output layout.

4. The control point according to claim 1, further comprising a lookup table update unit to update the lookup table using a printing time for the printing job when printing of the printing job has been completed.

5. The control point according to claim 1, wherein the format selector selects a printing data format using a size of a content which is commanded to be printed and the lookup table.

6. The control point according to claim 1, wherein the user interface receives setting of printing options for the printing data,
wherein the format selector selects a printing data format using an output layout among the set printing options and the lookup table.

7. The control point according to claim 1, wherein the communication interface searches for connectible image forming apparatuses if a printing command is received,
wherein the user interface receives a selection of an image forming apparatus to perform a printing job from the searched image forming apparatuses.

8. A method for controlling a printing operation of a control point which is connected to a plurality of image forming apparatuses using a digital living network alliance (DLNA), the method comprising:
selecting an image forming apparatus to perform a printing job among the image forming apparatuses connected using the DLNA;
selecting a printing data format using a lookup table which records at least one of information of printing data formats supportable by the selected image forming apparatus and printing time information;
generating printing data according to the selected printing data format; and
transmitting the generated printing data to the selected image forming apparatus.

9. The method according to claim 8, wherein the lookup table comprises a table which contains printing times classified by content size.

10. The method according to claim 8, wherein the lookup table comprises a table which contains predetermined printing data formats classified by content size and output layout.

11. The method according to claim 8, further comprising updating the lookup table using the printing time for the printing job when printing of the printing job has been completed.

12. The method according to claim 8, wherein the selecting the printing data format comprises selecting a printing data format using a size of a content which is commanded to be printed and the lookup table.

13. The method according to claim 8, further comprising receiving setting of printing options for the printing data,
wherein the selecting the printing data format comprises selecting a printing data format using an output layout among the set printing options and the lookup table.

14. The method according to claim 8, further comprising searching for an image forming apparatus if a printing command is received,
wherein the selecting the image forming apparatus comprises selecting an image forming apparatus to perform a printing job among the searched image forming apparatuses.

15. The method according to claim 8, further comprising searching for a connectible image forming apparatus prior to a printing command being received.

16. The method according to claim 14, further comprising displaying connectible image forming apparatuses.
